(19) United States
(12) Patent Application Publication
(10) Pub. No.: US 2002/0073833 A1
(43) Pub. Date: Jun. 20, 2002

(54) Return to dig system

(76) Inventors: Edwin G. Coombs, Radfords (GB); Andy Redeker, Lancelot Close (GB); Charles M. Crowell JR., Swithland (GB); Joanne B. Schiernecker, Leicester (GB); Zach E. Kelsall, Leicester (GB)

Correspondence Address: CATERPILLAR INC., 100 N.E. ADAMS STREET, PATENT DEPT., PEORIA, IL, 616296490

(21) Appl. No.: 09/739,411

(22) Filed: Dec. 18, 2000

(51) Int. Cl. F15B 21/02

(52) U.S. Cl. 91/35; 91/392

(57) ABSTRACT

A return to dig system for a work machine having at least one implement is actuated by a hydraulic cylinder using a switch, such as with a push button, to control a valve and solenoid to move the implement from a remote position to a preselected position, usually the starting position. The preselected position is determined by a sensor and a detectable element, such as a magnet. The location of the detectable element may be adjusted to provide a plurality of preselected positions. When the detectable element is sensed, the solenoid is repositioned to stop movement of the implement. The push button is located on a device that controls the movement of the implement and various other functions of the work machine. The actuation of the return to dig system by the push button does not affect any other unrelated function of the work machine controlled by the device.

### TECHNICAL FIELD

This invention relates generally to electronic and hydraulic systems which return an implement to a desired position upon the completion of an operation. The system is particularly adapted to buckets and forks on wheel loaders but is applicable to any work piece used in repetitive operations.

### BACKGROUND ART

Motorized vehicles carrying various implements are routinely used in the materials handling and construction industries. Typically, these devices have a chassis, motor, transmission, hydraulic pump(s), a framework upon which an implement is mounted and a means for moving the implement, which almost always incorporates an hydraulic cylinder. Examples of such devices are tractors, track or wheel loaders, backhoes, excavators and forklifts. All of these devices are engaged in repetitive motions of some type such as lifting a load of material from the ground and transporting it to a conveyance such as a truck. The vehicle is then returned to the original location and the implement is lowered to the starting position. To achieve maximum production, the operator is simultaneously attempting to steer the vehicle and adjust the position of the implement. The process could be greatly simplified if the implement were simply to return to a preselected position without requiring the attention of the operator.

U.S. Pat. No. 4,011,959, to Papasideris granted Mar. 15, 1977 is directed to a bucket-positioning system which use proximity switches on the tilt jack cylinder as part of a control system to control the tilt of the bucket during elevation. Detent notches on the control lever handle hold the controller in a position selected by the operator and the bucket is stopped when the proximity switch is triggered.

U.S. Pat. No. 3,915,325, to Lark et al., granted Oct. 28, 1975 is directed to an indexing means using electromagnets to control the valving for the hydraulic system. The primary control method is a potentiometer. Selection is achieved by moving a control handle to a position where it is held in place magnetically until the relocation of the bucket is complete.

The present invention is directed to overcoming one or more of the deficiencies of the prior art in a reliable and cost effective manner.

### DISCLOSURE OF THE INVENTION

The invention is directed to a system to return an implement to a preselected position without requiring the operator to maintain real-time control of the implement while performing other operations.

In a first aspect of the invention, a system is disclosed on a work machine for returning an implement to a preselected position from a remote position. The implement is movable through the action of a hydraulic cylinder having a cylinder rod. The system comprises a movable control device for controlling a plurality of functions of the work machine including the movement of the implement. A sensor is affixable to said hydraulic cylinder and is superimposed over the path of extension of said cylinder rod. A detectable element is adjustably affixable to said cylinder rod. Means other than movement of the control device are provided for directing motion of said hydraulic cylinder to superimpose said sensor and said detectable element. Means are also provided for terminating motion of said hydraulic cylinder when said sensor and detectable element are superimposed.

In a second aspect of the invention, a method is disclosed for returning an implement on work machine from a remote position to a preselected position. The method comprises moving the implement to the remote position by a control device that actuates a cylinder rod on a hydraulic cylinder, The control device also controls other functions of the work machine that are not related to the movement of the implement. Then, moving the implement toward the preselected position by using a switch to actuate the cylinder rod. Next, advancing a detectable element to a sensed position on the cylinder rod. Finally, sensing the detectable element terminates the movement of the cylinder rod.

The present invention allows for a simple method for returning an implement to a preselected position through the use of a convenient switch on a device that controls the movement of the implement so that no other unrelated function of the work machine controlled by the device is affected.

### BRIEF DESCRIPTION OF THE DRAWINGS

FIG. 1 is a side view of a forward portion of a loader machine or wheel-type loader;

FIG. 2 is a block diagram of the return to dig concept;

FIG. 3 is a block diagram of the electrical concept layout;

FIG. 4A shows a plan view for the sensing means for determining the desired position for the cylinder rod which determines the position of the implement; and

FIG. 4B is a side elevation showing the relationship between sensor rod and positioned magnet.

### BEST MODE FOR CARRYING OUT THE INVENTION

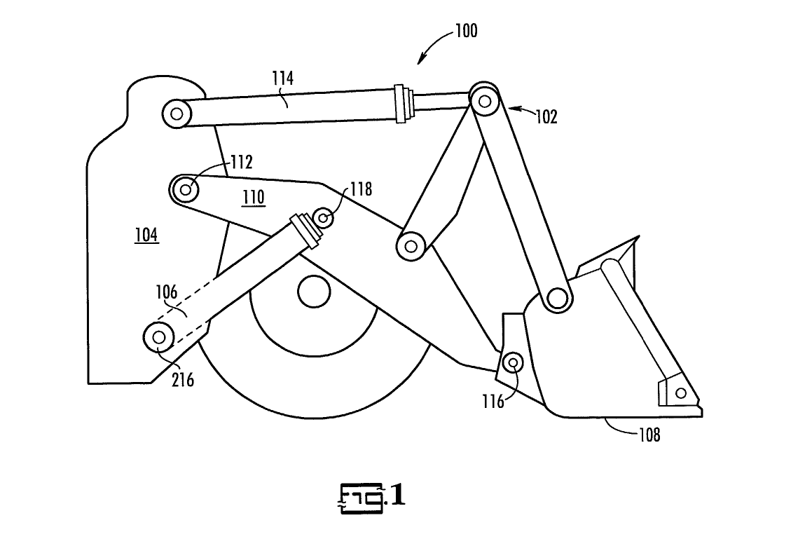

In FIG. 1, an implement control system is generally represented by the element number 100. FIG. 1 shows a forward portion of a wheel type loader machine 104 having a payload carrier in the form of a bucket 108. Although the present invention is described in relation to wheel type loader machine, the present invention is equally applicable to many earth working machines such as track type loaders, hydraulic excavators, and other machines having similar loading implements. An implement 108, such as a bucket, is connected to a lift arm assembly or boom 110, which is pivotally activated by one or more hydraulic lift actuators or cylinders 106 (only one shown) about a boom pivot pin 112 that is attached to the machine frame. A boom load bearing pivot pin 118 is attached to the boom and lift cylinders 106. The implement is tilted by a bucket tilt actuator or cylinder 114 about a tilt pivot pin 116.

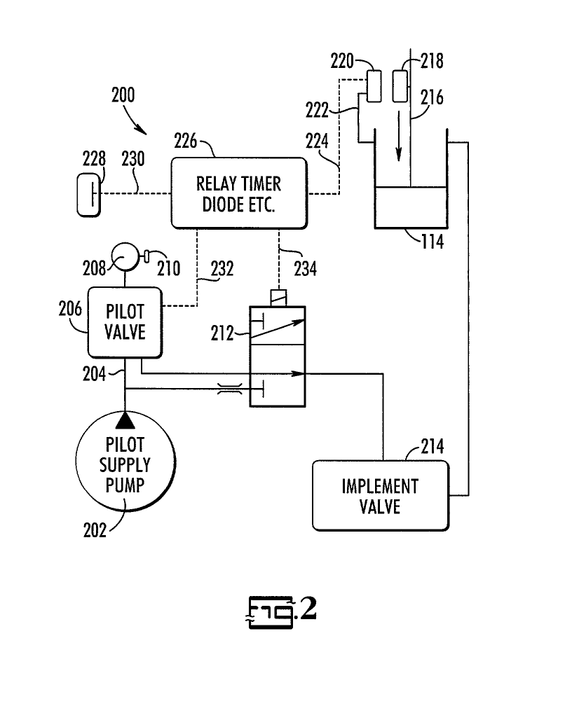

FIG. 2 is a box diagram of the return to dig system 200. Pilot supply hydraulic pump 202 supplies hydraulic fluid under pressure through pipe 204 to pilot valve 206. Joystick 208, which may be connected directly to pilot valve 206 or operating at a distance using conventional “fly-by-wire” technology is the normal control for the tilt cylinder 114. The joystick 208 may and preferably does control other operating functions including steering and locomotion. The joystick 208 has been modified with a push button switch 210. The pilot signal line that controls tilt cylinder retraction has been modified with solenoid valve 212. Hydraulic fluid from the pilot valve 206 is conventionally directed through solenoid valve 212 to implement valve 214 for distribution to tilt cylinder 114. Return to dig is engaged by using on\off switch 228. When engaged, actuation of push button 210 through relay and timer 226 directs the solenoid valve 212 to energize. This sends a pilot signal to the implement valve 214 bypassing pilot valve 206 until the bucket 108 is automatically returned to the preselected position. Return is automatic and does not affect other functions of the joystick 208. Sensor 220 detects magnet 218 on rod 216 and signals the relay/timer through harness wire 224 to stop movement of the cylinder rod 216 by resetting the position of the solenoid valve 212.

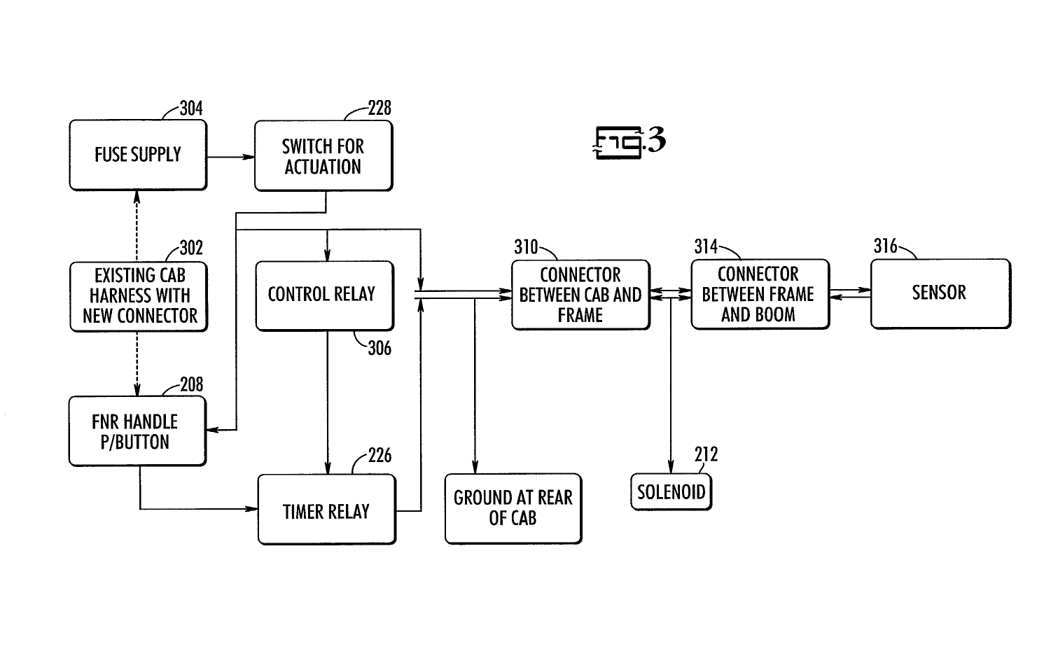

Referring to FIG. 3, the electrical layout 300 for the return to dig is connected to an existing wiring harness in the cab using connector 302 or equivalent means. The circuit is fused at fuse panel 304 and activates the switch 228. The push button 210 on joystick handle 208 activates timer relay 226 to engage a control relay 306. Using a plug type connector 310, the wiring harness is connected to a ground and to the solenoid 212. Continuing forward, connector 314 connects the boom to the harness on the frame and from the boom connector to the sensor 316.

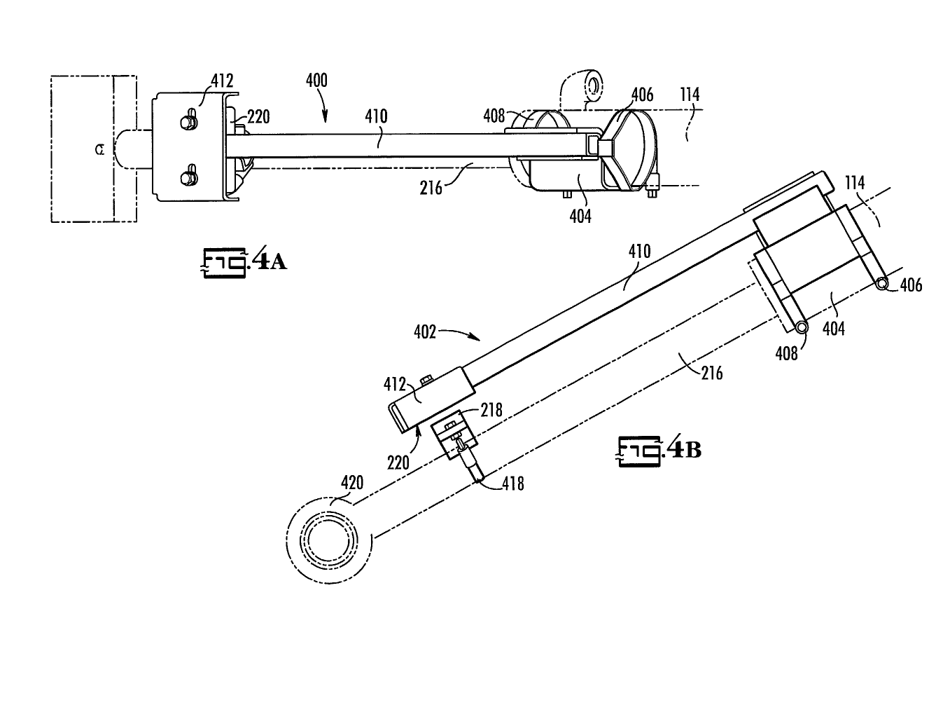

FIG. 4A is a plan view 400 of the sensor system as attached to the tilt cylinder 114. FIG. 4B is a side view of the same system. A bracket 404 is mounted to the actuator tilt cylinder 114 using straps 406 and 408. Extension arm 410 attaches to bracket 404 and runs parallel to rod 216. At the end of extension arm 410 a housing 412 holds sensor 220 which detects the presence of magnet 218 attached to rod 216 using bracket and strap 418 or equivalent fixing means. The bracket and strap 418 is adjustable relative to rod end 420 to allow adjustment of the implement position and the end of the return process.

Industrial Applicability

Earth working machines such as wheel type loaders include work implements capable of being moved through a number of positions during a work cycle. The work cycle typically associated with a bucket includes positioning of the boom and bucket in a digging position to fill the bucket with a material (usually a starting position), a carrying position while the loader addresses the truck or alternative location for depositing a material, and raised and dumping positions for removal of the material from the bucket.

In operation, it is important to be able to simply and efficiently return the bucket 108 to the digging position from any of the other remote positions. For that reason, the digging position of the magnet 218 is set on cylinder rod 216 and the bucket 108 is operated in the conventional manner. Generally, when the tilt cylinder 114 is in an extended position and the magnet 218 is located elevationally above the sensor 220, the system switch 228 may be activated and push button 210 depressed to return the bucket 108 to the digging position. At that time, the solenoid 212 comes under the control of relay timer 226 and directs the implement valve 214 to provide hydraulic fluid to the tilt cylinder 114 until the sensor 220 detects the magnet 218 at which point the relayed timer 226 is signaled and the solenoid valve 212 is repositioned to terminate movement of the tilt cylinder 114, and, thus, the movement of the implement 108 is terminated. After the tilt cylinder 114 movement is terminated, the operator is now in a position to commence the next operation of the implement 108. It should be understood that at any time after the push button 210 is depressed the first time, the operator may depress the push button 210 a second time to terminate the movement of the tilt cylinder 114. Also, movement of the joystick in a certain manner other than for “rack-back” control may incrementally slow or even terminate the movement of the tilt cylinder 114. Further, during the movement of the tilt cylinder 114, the operator may use the joystick 208 for controlling the various other functions of the work machine 104, such as for steering or direction, without affect from the return to dig system 200. This is possible due to the fact that the movement of the tilt cylinder 114 during the automatic return to dig is activated by the push button 210 located on the joystick 208 but is not related to movement of the joystick 208 itself.

It should be understood that if the tilt cylinder 114 is in a particular position where the magnet 218 is located elevationally below the sensor 220, the system switch 228 may also be activated and push button 210 depressed to return the bucket 108 to the digging position. Again, in this situation, the solenoid 212 comes under the control of the relay timer 226 and directs the implement valve 214 to provide hydraulic fluid to tilt cylinder 114. Howeever, because the sensor 220 will never detect the magnet 218 due to their relative positions, the timer relay 226 signals the solenoid valve 212 to reposition and terminate movement of the tilt cylinder 114 after a preset amount of time has passed.

It should be understood that while the function of the preferred embodiment as described above in connection with a bucket in connection with a boom and associated with hydraulic circuit, the present invention is adapted to control the position of implements of other types on earth working machines. For example, the present invention could be employed to control implements on hydraulic excavators, backhoes, forklifts and similar machines having hydraulically operated implements. Further, it should be understood that although only a tilt cylinder 114 is controlled by the return to dig system 200, various other cylinders or similar means may be controlled without departing from the scope of the invention.

Finally, it should be understood that the present invention may be incorporated as an after-market upgrade that can be readily affixed to existing tilting implements.

Other aspects, objects and advantages of the present invention may be obtained from a study of the drawings, the disclosure and the appended claims.

1. A system on a work machine for returning an implement to a preselected position from a remote position, the implement movable through the action of a hydraulic cylinder having a cylinder rod, the system comprising:
a movable control device for controlling a plurality of functions of the work machine including the movement of the implement;
a sensor affixable to said hydraulic cylinder, said sensor being superimposed over the path of extension of said cylinder rod;
a detectable element adjustably affixable to said cylinder rod;
means other than movement of the control device for directing motion of said hydraulic cylinder to superimpose said sensor and said detectable element; and
means for terminating motion of said hydraulic cylinder when said sensor and detectable element are superimposed.

2. The system according to claim 1 wherein said sensor is a magnetometer and said detectable element is a magnet.

3. The system according to claim 1 wherein said means for directing motion comprises first and second switches, a relay, a solenoid, and a pilot valve.

4. The system according to claim 3 wherein said first switch is located on the control device and said second switch, relay, solenoid, and pilot valve are located remotely from the control device.

5. The system according to claim 1 wherein said means for terminating motion comprises a relay and a solenoid.

6. A method for returning an implement on a work machine from a remote position to a preselected position, comprising:
moving the implement to the remote position by a control device that actuates a cylinder rod on a hydraulic cylinder, said control device also controlling other functions of the work machine not related to the movement of the implement;
moving the implement toward the preselected position by using a switch to actuate the cylinder rod;
advancing a detectable element to a sensed position on the cylinder rod; and
sensing the detectable element terminates the movement of the cylinder rod.

7. The method according to claim 6 wherein the step of moving the implement toward the preselected position by using the switch includes the step of:
actuating a second switch, a timer relay, a solenoid, and a pilot valve.

8. The method according to claim 6 wherein the step of moving the implement toward the preselected position by using the first switch includes the step of:
substantially not affecting the use of the control device for any function of the work machine.

9. The method according to claim 6 wherein the step of moving the implement toward the preselected position by using the first switch includes the step of:
totally not affecting the use of the control device for any other function of the work machine not related to the movement of the implement.

10. The method according to claim 6 wherein the step of moving the implement toward the preselected position by using the switch includes the steps of:
pushing the switch a first time to actuate the cylinder rod; and
pusing the switch a second time to interrupt the movement of the implement toward the preselected position.

11. The method according to claim 6 wherein the step of sensing the detectable element includes the step of:
returning full control of the implement to an operator.

12. The method according to claim 6 wherein the step of sensing the detectable element terminates the movement of the cylinder rod includes the step of:
overriding the sensing of the detectable element to terminate the movement of the cylinder rod if the sensing of the detectable element does not occur within a preselected time period.

13. The method according to claim 6 wherein the step of moving the implement toward the preselected position by using a switch includes the step of:
incrementally slowing the movement of the implement toward the preselected position through movement of the control device in a particular manner.
